(19) United States
(12) Patent Application Publication
(10) Pub. No.: US 2020/0068607 A1
(43) Pub. Date: Feb. 27, 2020

(54) TERMINAL SCHEDULING METHOD, TERMINAL AND BASE STATION

(71) Applicant: VIVO MOBILE COMMUNICATION CO., LTD., Chang'an DongGuan City (CN)

(72) Inventors: Lei JIANG, Chang'an DongGuan City (CN); Yu DING, Chang'an DongGuan City (CN); Xiaodong SHEN, Chang'an DongGuan City (CN)

(21) Appl. No.: 16/467,443

(22) PCT Filed: Nov. 30, 2017
(86) PCT No.: PCT/CN2017/113778

§ 371 Date: Jun. 6, 2019

(30) Foreign Application Priority Data
Dec. 8, 2016 (CN) 201611122271.X

(51) Int. Cl. H04W 72/12; H04L 5/00; H04W 72/04; H04L 25/02

(52) U.S. Cl. CPC H04W 72/1289; H04L 5/0053; H04L 25/0238; H04L 5/0007; H04W 72/042

(57) ABSTRACT

A terminal scheduling method, a terminal and a base station are provided in the present disclosure, to solve the issue that it is difficult for the base station in the future mobile communication system to flexibly schedule terminal to perform the data transmission on the resources of different carrier interval configurations. The terminal scheduling method includes: sending scheduling information carrying numerology information to a terminal. The base station sends the scheduling information carrying the numerology information to the terminal, and the terminal performs the data transmission on the scheduling resource based on the scheduling information carrying the numerology information, thereby enabling the base station in the future mobile communication system to flexibly schedule the terminal to perform the data transmission on the resources with different numerology information and improving the system performance.

### CROSS REFERENCE OF RELATED APPLICATION

The present application is the U.S. national phase of PCT Application PCT/CN2017/113778 filed on Nov. 30, 2017, which claims a priority of Chinese patent application No. 201611122271.X filed on Dec. 8, 2016, which is incorporated herein by reference in its entirety.

### TECHNICAL FIELD

The present disclosure relates to the field of communication technologies, and in particular, to a terminal scheduling method, a terminal and a base station.

### BACKGROUND

Compared with previous mobile communication systems, the mobile communication systems in the further need to adapt to more diverse scenarios and business needs. For example, the main scenarios of 5G mobile communication systems include Enhanced Mobile Broadband (eMBB), Ultra Reliable & Low Latency Communication (URLLC), and Massive Machine Type Communication (mMTC). These scenarios have requirements for high reliability, low latency, large bandwidth and wide coverage for the system. In order to meet different requirements of services and different application scenarios, the subcarrier interval of the 5G system is no longer a single 15 kHz as in LTE. In contrast, a 5G system is able to support multiple subcarrier intervals, and different subcarrier intervals may be applied to different scenarios. For example, for high frequency band and large bandwidth, a relatively large subcarrier interval can be configured. At the same time, the large subcarrier interval corresponds to a small symbol length in the time domain, thereby meet the requirements of low latency services.

In the 5G technology solution, the subcarrier interval of the system can be 2n*15 kHz. At the same time, these different subcarrier intervals can exist on the same carrier, that is, different carrier numerology can be multiplexed. Different services or different application scenarios use their respective numerology.

When a user equipment (UE) supports multiple types of services, it needs to be scheduled on the numerology resources corresponding to different services. Specifically, when the service switching is relatively frequent, or when multiple services need to be supported at the same time, the 5G base station gNB needs to be able to schedule the UEs to perform transmission on the corresponding resources flexibly. At present, 3GPP supports multiplexing of multiple different subcarrier interval configurations in the time domain and the frequency domain. However, when multiple types of subcarrier interval numerology are multiplexed, there is no research on the scheduling problem of the UE, which makes it difficult for the base station to flexibly schedule terminals to perform the data transmission on the resources of different carrier interval configurations.

### SUMMARY

### (1) Technical Issues to be Solved

The present disclosure provides a terminal scheduling method, a terminal and a base station, to solve the issue that it is difficult for the base station in the future mobile communication system to flexibly schedule terminal to perform the data transmission on the resources of different carrier interval configurations.

### (2) Technical Solution

In a first aspect, a terminal scheduling method is provided in the embodiment of the present disclosure, which is applied to a base station and includes:

sending scheduling information carrying numerology information to a terminal.

In a second aspect, a terminal scheduling method is further provided in the embodiment of the present disclosure, which is applied to a base station and includes:

receiving scheduling information carrying numerology information sent by the base station; and

performing data transmission on a scheduling resource based on the scheduling information.

In a third aspect, a base station is further provided in the embodiment of the present disclosure, including:

a sending module configured to send scheduling information carrying numerology information to a terminal.

In a fourth aspect, a terminal is further provided in the embodiment of the present disclosure, including:

a second acquiring module, configured to acquire scheduling information carrying numerology information sent by a base station; and

a transmitting module, configured to perform data transmission on a scheduling resource based on the scheduling information.

In a fifth aspect, a base station is further provided in the embodiment of the present disclosure, including a processor, a memory and a computer program stored in the memory and operable by the processor, where the processor executes the computer program to perform the terminal scheduling method hereinabove.

In a sixth aspect, a terminal is further provided in the embodiment of the present disclosure, including a processor, a memory and a computer program stored in the memory and operable by the processor, where the processor executes the computer program to perform the terminal scheduling method hereinabove.

In a seventh aspect, a computer readable storage medium is further provided in the embodiment of the present disclosure, where a computer program is stored in the computer readable storage medium, the computer program is executed by a processor to program to perform the terminal scheduling method hereinabove.

In an eighth aspect, a computer readable storage medium is further provided in the embodiment of the present disclosure, where a computer program is stored in the computer readable storage medium, the computer program is executed by a processor to program to perform the terminal scheduling method hereinabove.

### (3) Beneficial Effects

According to the above embodiments of the present disclosure, the base station sends the scheduling information carrying the numerology information to the terminal, and the terminal performs the data transmission on the scheduling resource based on the scheduling information carrying the numerology information, thereby enabling the base station in the future mobile communication system to flexibly schedule the terminal to perform the data transmission on the resources with different numerology information and improving the system performance.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flow chart of a terminal scheduling method in a first embodiment of the present disclosure;

FIG. 2 is a flow chart of a terminal scheduling method in a first embodiment of the present disclosure;

FIG. 3 is a flow chart of a terminal scheduling method in a second embodiment of the present disclosure;

FIG. 4 is a schematic view of time division multiplexing of numerology information of a scheduling resource in the second embodiment of the present disclosure;

FIG. 5 is a schematic view of the frequency division multiplexing of numerology information of a scheduling resource in the second embodiment of the present disclosure;

FIG. 6 is a schematic view of scheduling information transmitted by multiple control channels in the second embodiment of the present disclosure;

FIG. 7 is a schematic view of scheduling information transmitted by a single control channel in the second embodiment of the present disclosure;

FIG. 8 is another schematic view of scheduling information transmitted by a single control channel in the second embodiment of the present disclosure;

FIG. 9 is a schematic view of a base station in a first embodiment of the present disclosure;

FIG. 10 is another schematic view of a base station in the first embodiment of the present disclosure;

FIG. 11 is another schematic view of a base station in a second embodiment of the present disclosure;

FIG. 12 is a flowchart of a terminal scheduling method in a third embodiment of the present disclosure;

FIG. 13 is a flowchart of a terminal scheduling method in a fourth embodiment of the present disclosure;

FIG. 14 is a schematic view of a terminal in a first embodiment of the present disclosure;

FIG. 15 is another schematic view of a terminal in the first embodiment of the present disclosure;

FIG. 16 is a schematic view of a terminal in a second embodiment of the present disclosure; and

FIG. 17 is a schematic view of a terminal in a third embodiment of the present disclosure.

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

### First Method Embodiment

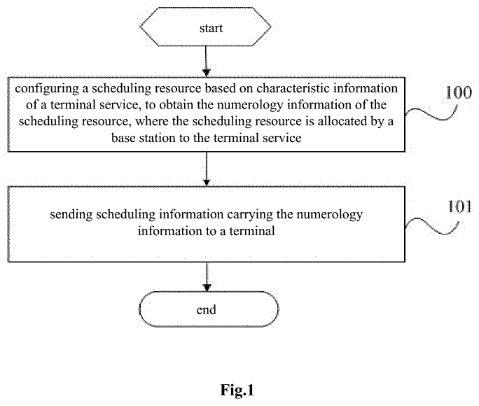

As shown in FIG. 1, a terminal scheduling method is provided in some embodiments of the present disclosure, which is applied to a base station and includes:

Step 101: sending scheduling information carrying numerology information to a terminal.

Correspondingly, the scheduling information that carries the numerology information is sent to the terminal, so that the terminal may perform data transmission on the corresponding scheduling resource according to the scheduling information.

Here, the numerology information may specifically include: a subcarrier interval, a cyclic prefix CP. The numerology information may be specifically obtained by configuring a scheduling resource based on characteristic information of the terminal service by the base station, or the base station may obtain the numerology information corresponding to the current service according to the pre-configured correspondence between the service and the numerology information, the embodiments of the present disclosure are not limited thereto.

In addition, on which numerology resources the terminal performs the data transmission, may be triggered by the terminal based on the service and report the result to the base station, and then the base station may perform the scheduling on the corresponding resource, or may be triggered by the base station based on the service and notify the terminal through a Radio Resource Control (RRC) or a Downlink Control Information (DCI). RRC is suitable for semi-static scheduling transformation, and DCI is suitable for dynamic scheduling transformation. The information about the system numerology can be obtained by the UE after the UE accesses the system, therefore regardless of whether the result of which numerology resources the terminal performs the data transmission is reported by the terminal issued by the base station, the numerology number or index corresponding to the resource to be scheduled may be required to be indicated.

Optionally, before sending the scheduling information carrying the numerology information to the terminal, the terminal scheduling method further includes:

Step 100: configuring a scheduling resource based on characteristic information of a terminal service, to obtain the numerology information of the scheduling resource, where the scheduling resource is allocated by the base station to the terminal service.

The characteristic information of the terminal service may include delay requirement information of the service, and the like.

The subcarrier interval configuration and the CP configuration are performed on the corresponding scheduling resources based on the characteristic information of the terminal service, so as to meet the requirements for different service transmissions in the future mobile communication system.

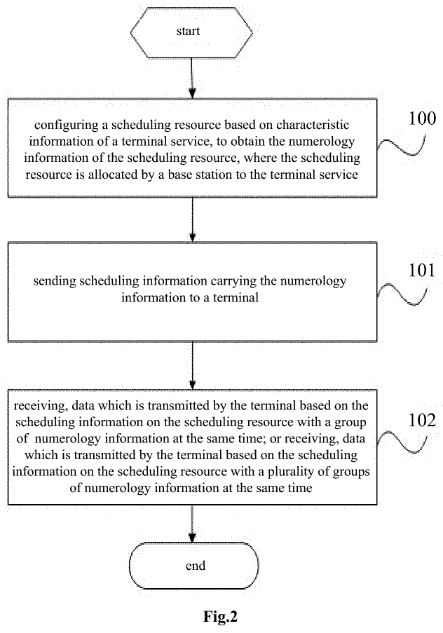

Further, as shown in FIG. 2, after the above Step 101, the terminal scheduling method further includes:

Step 102: receiving, data which is transmitted by the terminal based on the scheduling information on the scheduling resource with a group of numerology information at the same time; or receiving, data which is transmitted by the terminal based on the scheduling information on the scheduling resource with a plurality of groups of numerology information at the same time.

Here, the base station may determine a scheduling mode according to the terminal capability reported by the terminal, and schedule the terminal according to the determined scheduling mode. The terminal capability includes whether the terminal supports transmission on resources with different numerology information, and whether the terminal supports transmission on resources with different numerology information at the same time. The above scheduling manner includes scheduling terminals to perform data transmission on resources with different numerology information at different times, or scheduling terminals to perform data transmission on resources with multiple numerology at the same time.

For a terminal, if only one type of service is supported at a time, it will only be scheduled on a resource with one configuration information. However, at different times, the terminal may be scheduled on resources with different numerology information due to changes in services. When a terminal has the ability to support at least two services at the same time, due to different service requirements, it may be scheduled on resources with different numerology information at the same time, such as the multiplexing of URLLC and eMBB. In this case, the terminal may be scheduled on the resources with different numerology information at the same time, thereby enabling the base station to flexibly schedule the terminal to transmit data on resources with different numerology information according to the terminal service requirement.

According to the above embodiments of the present disclosure, the base station sends the scheduling information carrying the numerology information to the terminal, and the terminal performs the data transmission on the scheduling resource based on the scheduling information carrying the numerology information, thereby enabling the base station in the future mobile communication system to flexibly schedule the terminal to perform the data transmission on the resources with different numerology information and improving the system performance.

### Second Method Embodiment

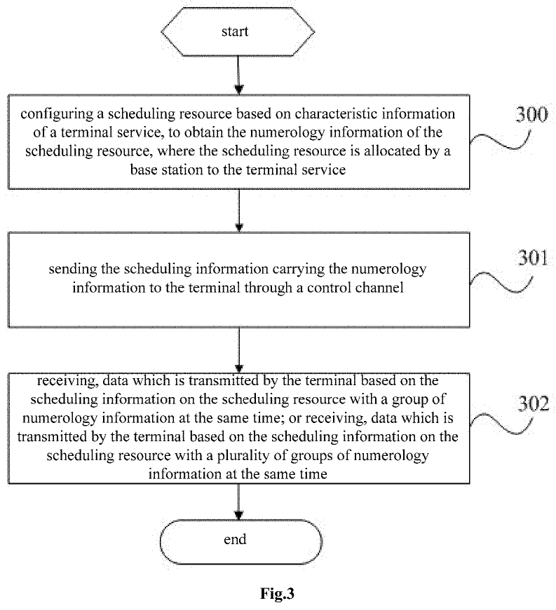

As shown in FIG. 3, the terminal scheduling method of the embodiment of the present disclosure includes:

Step 300: configuring a scheduling resource based on characteristic information of a terminal service, to obtain the numerology information of the scheduling resource, where the scheduling resource is allocated by a base station to the terminal service.

The characteristic information of the terminal service may include delay requirement information of the service, and the like.

The subcarrier interval configuration and the CP configuration are performed on the corresponding scheduling resources based on the characteristic information of the terminal service, so as to meet the requirements for different service transmissions in the future mobile communication system.

Step 301: sending the scheduling information carrying the numerology information to the terminal through a control channel.

The scheduling information carrying the numerology information is sent to the terminal through the control channel, so that the terminal may accurately obtain the scheduling information through the DCI or the blind detection, thereby enabling the terminal to perform data transmission on the resource with different numerology information according to the scheduling information.

In order to schedule the terminal on different numerology resources, the base station may place the scheduling information on the corresponding numerology subband, or place the scheduling information on one of the numerology subbands or on the common control channel resource. The numerology information of the common control channel resource may be different from the numerology information of the scheduled resource.

Specifically, in the case that the numerology information includes a group of numerology information, the scheduling information carrying the numerology information is sent to the terminal through one control channel.

In the case that the numerology information includes at least two groups of numerology information, at least two scheduling information carrying the numerology information are sent to the terminal through one or at least two control channels, where each scheduling information carries one group of numerology information in the numerology information.

The embodiment of transmitting scheduling information carrying the numerology information to the terminal through the control channel is specifically described below with reference to FIG. 4 to FIG. 8.

### First Embodiment

In the case that the numerology information includes a group of numerology information, the scheduling information carrying the numerology information is sent to the terminal through one control channel.

As shown in FIG. 4, when the numerology is performed in a time division multiplexing manner, the system performs a transformation of numerology information at different time lines for different services. During the scheduling, the base station may add in the DCI of the previous control channel a bit indicating the numerology information of the next resource to be scheduled, such as the number/index of the numerology information. The number of added bits depends on the number of numerology that can be scheduled. The terminal uses the corresponding numerology information to detect the control channel at the next scheduling time. This method is suitable for a frequent business switching. When the terminal fails to correctly detect the previous physical downlink control channel PDCCH or the previous subframe/slot/sub-slot has no data transmission, the UE cannot obtain the numerology information of the next time point, and then the terminal performs blind detection at the current time point to obtain the corresponding scheduling information.

When the service switching is infrequent, the new numerology information may be indicated in the RRC, including at least one of a starting position of the new numerology information, the duration, the numerology information number/index, the subcarrier interval and the CP.

On the other hand, as shown in FIG. 5, when the numerology is performed in a frequency division multiplexing manner, in the case that the terminal supports scheduling on resources with different numerology information at different times, the base station may add bits in the DCI to indicate the next numerology information to be used. At the next configuration time point, the UE performs a blind detection on the control channels such as the physical downlink control channel PDCCH/enhanced physical downlink control channel e-PDCCH/dedicated physical control channel D-PDCCH for the corresponding subband. The number of added bits depends on the number of numerology that can be scheduled. For example, as shown in FIG. 5, there are three numerology on the entire frequency band, and then 2 bits are required to indicate the number or index of the next numerology information, and the corresponding subband is found according to the number or index for the detection. Similarly, in the case that the terminal fails to correctly detect the previous PDCCH or the previous subframe/slot/sub-slot has no data transmission/PDCCH, the terminal cannot obtain the Numerology information at the next time point, and then the UE performs a blind detection at the current time point to obtain the corresponding scheduling information. In order to save the signaling overhead, the terminal may also perform the blind detection on the entire frequency band to obtain corresponding scheduling information. At the same time, in order to reduce the number of blind detections, the conversion frequency of the numerical configuration may be limited.

For example, if the terminal is continuously scheduled for more than X ms on a certain numerology resource, it can be scheduled on another numerology resource. In this way, the UE does not need to perform a blind detection on the scheduling information for the entire frequency band within this X ms, and the blind detection of the entire bandwidth may be continued from the X+1 ms. After the scheduling information with different numerology information is detected, for example, at X+2 ms, the entire bandwidth will not be subjected to the blind detection within the next X ms, and the control channel is detected only on the subband corresponding to f3. The size of X affects the flexibility of scheduling. Specifically, the smaller X is, the higher the flexibility may be.

The multi-carrier interval multiplexing of the 5G system can be in the time domain or in the frequency domain. When the multi-carrier interval is performed in the time division multiplexing manner, different subcarrier intervals are used in different time periods, and the subcarrier intervals in the entire frequency band are the same, as shown in FIG. 4, When the multi-carrier interval is performed in the frequency division multiplexing manner, different carrier intervals are used on different subbands in the frequency domain, and this configuration is constant in the time domain, as shown in FIG. 5.

### Second Embodiment

In the case that the numerology information includes at least two sets of numerology information, the scheduling information is respectively transmitted to the terminal through a control channel of the subband corresponding to the numerology information in the scheduling information.

In the case that the terminal supports transmitting multiple different services simultaneously on different numerology resources, the terminal needs to detect the scheduling information on these different numerology resources, including Modulation and Coding Scheme (MCS), resource allocation. Field resource block assignment, etc. At this time, a plurality of scheduling information may be transmitted using a plurality of control channels, for example, in subbands of different numerology information.

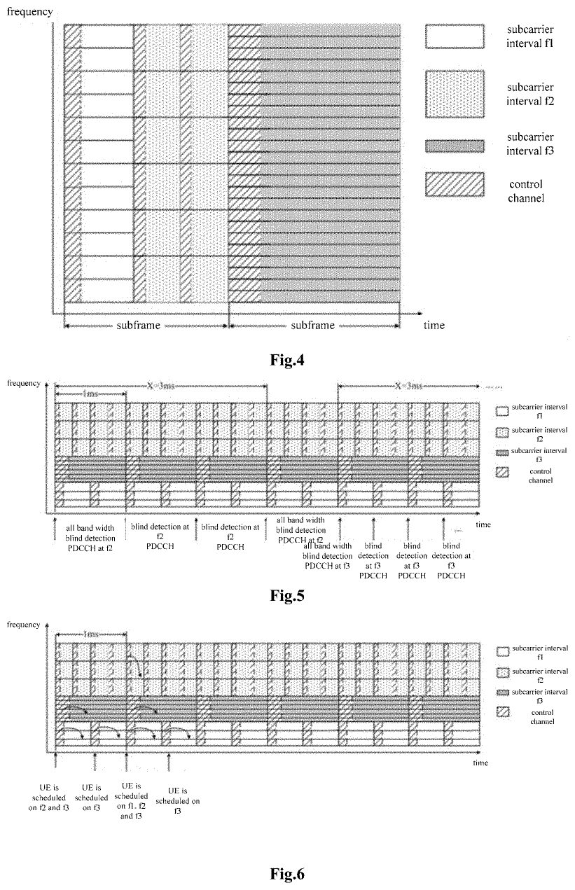

As shown in FIG. 6, the terminal can simultaneously detect and receive multiple control channels and perform data reception (downlink) or transmission (uplink) according to corresponding scheduling information. In addition, the terminal can perform the detection on the subbands of different numerology, and each of the detected control channels is received or transmitted according to the corresponding scheduling information.

### Third Embodiment

In the case that the numerology information includes at least two sets of numerology information, a plurality of scheduling information carrying the numerology information is sent to the terminal through the control channel of any subband corresponding to the numerology information in the scheduling information.

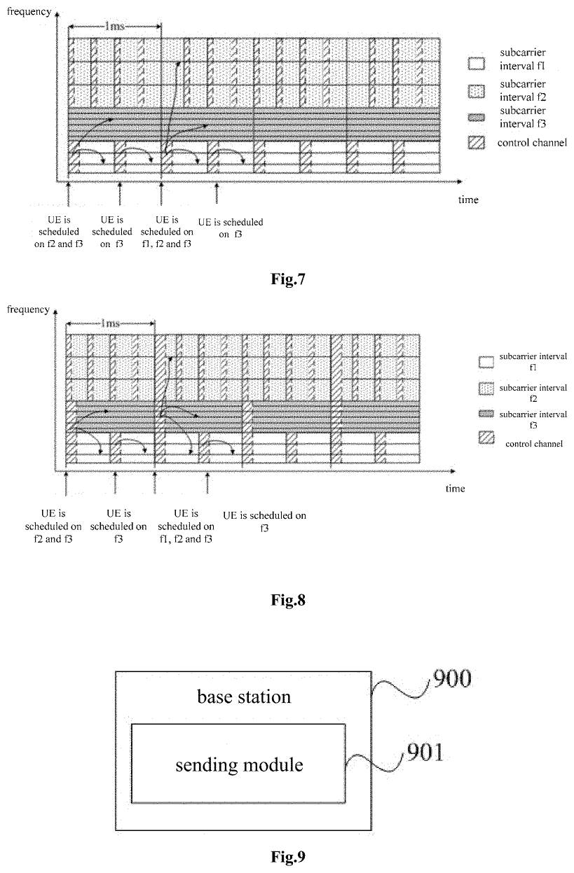

When the scheduling information of the different numerology subbands is included in the same control channel, as shown in FIG. 7, the control channel of a certain subband can schedule resources on a plurality of different numerology subbands. The subband of the control channel may be the original anchor numerology subband of the terminal. The anchor numerology subband is a numerology subband used before multi-numerology scheduling, or a long-term scheduled numerology subband, for example, f3 in FIG. 7.

In addition, the subband resource scheduling information may be subband-specific or global. When the subband resource scheduling information is subband-specific, the scheduling of each subband is independent. Each subband can use an independent MCS, an independent transmission mode, and the like. At this time, it is necessary to add a bit in the DCI to indicate corresponding information, and it is necessary to indicate the corresponding numerology subband. At this time, the sequence number/index number of the physical resource block PRB may be global or subband-specific, that is, the sequence number/index number of the PRB is globally unique, or the subband is unique.

When the subband resource scheduling information is global, the scheduling flexibility will be affected, but the number of DCI bits can be saved. In addition to physical resource block information on different subbands, most of the other scheduling information can be shared, for example, using the same MCS. At this time, the serial number/index number of the PRB is globally unique.

When the sequence number/index number of the PRB is globally unique, the sequence number/index number depends on the subcarrier interval and subband bandwidth of different numerology. Then, the serial numbers/index numbers of the PRB are in a one-to-one correspondence to the numerology of the entire system bandwidth. According to this correspondence, the UE does not need to additionally inform the numerology information when scheduling, such as carrier interval, subband frequency domain location information (bandwidth and/or center carrier frequency/DC carrier position, and/or start end position, etc.). The terminal can obtain the numerology subband of the PRB according to the serial number/index number of the PRB.

When the sequence number/index number of the PRB is subband-specific, for the subband of each numerology is configured, the sequence number/index number of the PRB starts from 0. At this time, the number/index of the numerology shall be included in the DCI of the control channel.

### Fourth Embodiment

If the numerology information includes at least two groups of numerology information, a plurality of scheduling information carrying the numerology information is sent to the terminal through a single control channel, where the single control channel occupies a frequency domain resource corresponding to all the numerology information, and the single control channel and the frequency domain resource corresponding to the numerology information have the same or different groups of numerology information.

Another way to schedule a single control channel is that the control channel uses a single numerology on the entire scheduled bandwidth, as shown in FIG. 8. The control channel can be extended in all scheduled subbands. The numerology used by the control channel may be different from the numerology of the scheduled subband (subcarrier interval, CP, etc.), or one of the numerology may be used (subcarrier interval, CP, etc.). At this time, the numerology information of the control channel can be sent to the UE in advance by the base station (transmitted to the UE through RRC or DCI), or specified in the standard, or configured by the UE to perform the blind detection according to all available values. It can be seen that the scheduling method in the fourth embodiment is similar to the that in the third embodiment.

The scheduling information carrying the numerology information is sent to the terminal through the control channel, so that the terminal may accurately obtain the scheduling information through the DCI or the blind detection, thereby enabling the terminal to perform data transmission on the resource with different numerology information according to the scheduling information.

In addition, the terminal scheduling method in the embodiments of the present disclosure is applicable to the scheduling in all numerology multiplexing, including a downlink scheduling and an uplink scheduling, and the scheduling across sub-frames, across time slots, across sub-slots, etc., as well as the scheduling in the carrier aggregation, the dual connectivity or multiple connections. The control channel in the drawings does not necessarily occupy the frequency domain resources of the entire numerology, which may also be sent only on a part of the time-frequency resources.

Step 302: receiving, data which is transmitted by the terminal based on the scheduling information on the scheduling resource with a group of numerology information at the same time; or receiving, data which is transmitted by the terminal based on the scheduling information on the scheduling resource with a plurality of groups of numerology information at the same time.

This step is the same as Step 102 above, and details thereof are not described herein again.

According to the terminal scheduling method of in the embodiments of the present disclosure, the scheduling resource is configured according to the characteristic information of the terminal service, to obtain the numerology information of the scheduling resource, and the scheduling resource is a resource allocated by the base station for the terminal service. The scheduling information carrying the above numerology information is sent to the terminal through the control channel. The data which is transmitted by the terminal based on the scheduling information on the scheduling resource with a group of numerology information at the same time is received; or the data which is transmitted by the terminal based on the scheduling information on the scheduling resource with a plurality of groups of numerology information at the same time is received. Therefore, the data is transmitted on the scheduling resource with multiple groups of numerology information at the same time, thereby enabling the base station to flexibly schedule the terminal to perform a transmission on the resource with different numerology information in the 5G system and improving the system performance.

### First Embodiment of Base Station

As shown in FIG. 9, a base station 900 is provided in the embodiments of the present disclosure, including:

a sending module 901 configured to send scheduling information carrying numerology information to a terminal.

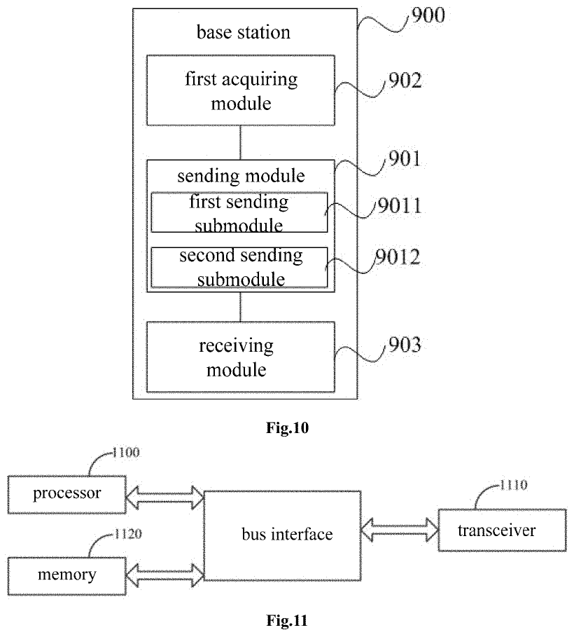

As shown in FIG. 10, the base station in the embodiments of the present disclosure further includes:

a first acquiring module 902, configured to configure scheduling resource based on characteristic information of a terminal service, to obtain the numerology information of the scheduling resource, where the scheduling resource is allocated by a base station to the terminal service.

The base station in the embodiments of the present disclosure further includes:

a receiving module 903, configured to receive data which is transmitted by the terminal based on the scheduling information on the scheduling resource with a group of numerology information at the same time; or

configured to receive data which is transmitted by the terminal based on the scheduling information on the scheduling resource with a plurality of groups of numerology information at the same time.

In the base station in the embodiments of the present disclosure, the sending module 901 is configured to send the scheduling information carrying the numerology information to the terminal through a control channel.

In the base station in the embodiments of the present disclosure, the sending module 901 includes:

a first sending submodule 9011, configured to send the scheduling information carrying the numerology information to the terminal through one control channel in the case that the numerology information includes a group of numerology information; and

a second sending submodule 9012, configured to send at least two scheduling information carrying the numerology information to the terminal through one or at least two control channels in the case that the numerology information includes at least two groups of numerology information, where each scheduling information carries one group of numerology information in the numerology information.

In the base station in the embodiments of the present disclosure, the second sending submodule 9012 is configured to send each scheduling information to the terminal, through the control channel of a subband corresponding to the numerology information in the scheduling information.

In the base station in the embodiments of the present disclosure, the second sending submodule 9012 is further configured to send the at least two scheduling information carrying the numerology information to the terminal, through the control channel of any subband corresponding to the numerology information in the at least two scheduling information.

In the base station in the embodiments of the present disclosure, the second sending submodule 9012 is further configured to send the at least two scheduling information carrying the numerology information to the terminal, through a single control channel, where the single control channel occupies a frequency domain resource corresponding to all the numerology information, and the single control channel and the frequency domain resource corresponding to the numerology information have the same or different groups of numerology information.

It should be noted that the base station is corresponding to the foregoing method embodiment. All the implementation manners in the foregoing method embodiments are applicable to the embodiment of the base station, and the same or similar technical effects can be achieved.

According to the base station in the embodiments of the present disclosure, the base station sends the scheduling information carrying the numerology information to the terminal, and the terminal performs the data transmission on the scheduling resource based on the scheduling information carrying the numerology information, thereby enabling the base station in the future mobile communication system to flexibly schedule the terminal to perform the data transmission on the resources with different numerology information and improving the system performance.

### Second Embodiment of Base Station

As shown in FIG. 11, in order to better achieve the above object, as shown in FIG. 11, the second embodiment of the base station of the present disclosure further provides a base station, where the base station includes: a processor 1100, a memory 1120 to which the processor 1100 is connected and a transceiver 1110 connected to the processor 1100 through a bus interface. The memory 1120 is configured to store programs and data used by the processor when performing operations. The data information or pilot is transmitted by the transceiver 1110, and the uplink control channel is also received by the transceiver 1110. When the processor 1100 calls and executes the program and data stored in the memory 1120, it is specifically configured to send scheduling information carrying the numerology information to the terminal.

The processor 1100 is configured to read a program in the memory 1120 to: send scheduling information carrying numerology information to a terminal. The transceiver 1110 is configured to receive and send data under the control of the processor 1100.

Optionally, the processor 1100 is further configured to: configure scheduling resource based on characteristic information of a terminal service, to obtain the numerology information of the scheduling resource, where the scheduling resource is allocated by the base station to the terminal service.

Optionally, the processor 1100 is further configured to: receive, data which is transmitted by the terminal based on the scheduling information on the scheduling resource with a group of numerology information at the same time; or receive, data which is transmitted by the terminal based on the scheduling information on the scheduling resource with a plurality of groups of numerology information at the same time.

Optionally, the processor 1100 is further configured to send the scheduling information carrying the numerology information to the terminal through a control channel.

Optionally, the processor 1100 is further configured to: send the scheduling information carrying the numerology information to the terminal through one control channel in the case that the numerology information includes a group of numerology information; send at least two scheduling information carrying the numerology information to the terminal through one or at least two control channels in the case that the numerology information includes at least two groups of numerology information, where each scheduling information carries one group of numerology information in the numerology information.

Optionally, the processor 1100 is further configured to each scheduling information to the terminal, through the control channel of a subband corresponding to the numerology information in the scheduling information.

Optionally, the processor 1100 is further configured to: send the at least two scheduling information carrying the numerology information to the terminal, through the control channel of any subband corresponding to the numerology information in the at least two scheduling information.

Optionally, the processor 1100 is further configured to send the at least two scheduling information carrying the numerology information to the terminal, through a single control channel, where the single control channel occupies a frequency domain resource corresponding to all the numerology information, and the single control channel and the frequency domain resource corresponding to the numerology information have the same or different groups of numerology information.

As shown in FIG. 11, the bus architecture can include any number of interconnected buses and bridges, specifically linked by one or more processors represented by processor 1100 and various circuits of memory represented by memory 1120. The bus architecture can also link various other circuits such as peripherals, voltage regulators, and power management circuits, which are well known in the art and, therefore, will not be further described herein. The bus interface provides an interface. The transceiver 1110 can be a plurality of components, including a transmitter and a transceiver, providing means for communicating with various other devices on a transmission medium. The processor 1100 is responsible for managing the bus architecture and general processing, and the memory 1120 can store data used by the processor 1100 in performing operations.

In this way, the base station sends the scheduling information carrying the numerology information to the terminal, and the terminal performs the data transmission on the scheduling resource based on the scheduling information carrying the numerology information, thereby enabling the base station in the future mobile communication system to flexibly schedule the terminal to perform the data transmission on the resources with different numerology information and improving the system performance.

In addition, it should be noted that in the apparatus and method of the present disclosure, it is apparent that various components or steps may be decomposed and/or recombined. These decompositions and/or recombination should be considered as equivalents to embodiments of the present disclosure. Also, the steps of performing the above-described series of processes may naturally be performed in chronological order in the order illustrated, but need not necessarily be performed in chronological order, and some steps may be performed in parallel or independently of each other. It will be apparent to those skilled in the art that all or any of the steps or components of the method and apparatus of the present disclosure may be in a network of any computing device (including a processor, storage medium, etc.) or computing device, in hardware, Firmware, software, or a combination thereof is implemented, which can be accomplished by one of ordinary skill in the art using their basic programming skills while reading the description of the present disclosure.

Accordingly, the objects of the present disclosure can also be implemented by running a program or a group of programs on any computing device. The computing device can be a well-known general-purpose device. Accordingly, the object of the present disclosure may also be achieved by merely providing a program product comprising program code for implementing the method or apparatus. That is, such program products also form part of the embodiments of the present disclosure, and storage media storing such program products also form part of the embodiments of the present disclosure. It will be apparent that the storage medium may be any known storage medium or any storage medium developed in the future. It should also be noted that in the apparatus and method provided by the embodiments of the present disclosure, it is apparent that the various components or steps may be decomposed and/or recombined. These decompositions and/or recombinations should be considered as equivalents to embodiments of the present disclosure. Also, the steps of performing the series of processes described above may naturally be performed in chronological order in the order illustrated, but need not necessarily be performed in chronological order. Certain steps may be performed in parallel or independently of one another.

The above are some embodiments of the present disclosure, and it should be noted that those skilled in the art can also make several improvements and modifications without departing from the principles described in the present disclosure, and these improvements and modifications are also within the scope of the present disclosure.

### Third Method Embodiment

As shown in FIG. 12, a terminal scheduling method is further provided in some embodiments of the present disclosure, which is applied to a terminal and includes:

Step 1201: receiving scheduling information carrying numerology information sent by a base station.

The numerology information herein may be specifically obtained by the base station which performs a configuration processing on the scheduling resource according to the characteristic information of the terminal service. The terminal may obtain the scheduling information carrying the numerology information through a control channel of the scheduling resource. The terminal obtains the scheduling information to perform a subsequent data transmission on the corresponding scheduling resource by using the scheduling information.

Step 1202: performing data transmission on a scheduling resource based on the scheduling information.

Optionally, the method further includes: performing the data transmission based on the scheduling information on the scheduling resource with a group of numerology information at the same time; or performing the data transmission based on the scheduling information on the scheduling resource with a plurality of groups of numerology information at the same time, to meet the requirements of different service transmissions in future mobile communication systems.

According to the terminal scheduling method in the above embodiments of the present disclosure, the scheduling information carrying numerology information sent by the base station is acquired, and data transmission is performed on a scheduling resource based on the scheduling information, thereby enabling the base station in the future mobile communication system to flexibly schedule the terminal to perform the data transmission on the resources with different numerology information and improving the system performance.

### Fourth Embodiment of Method

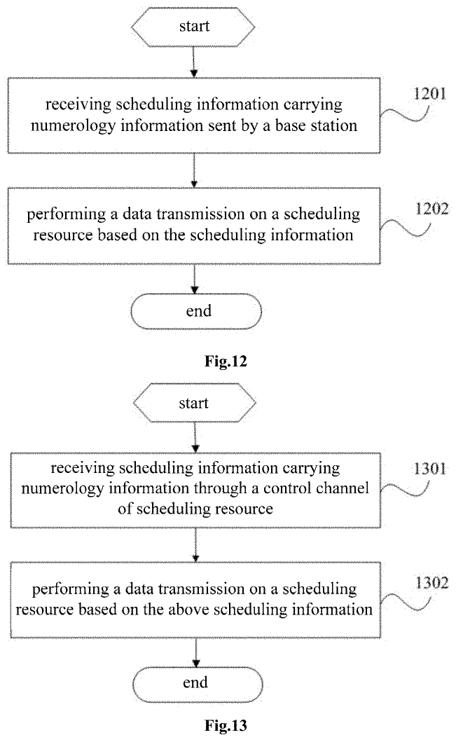

As shown in FIG. 13, a terminal scheduling method is further provided in the embodiments of the present disclosure, which is applied to a terminal and includes:

Step 1301: receiving scheduling information carrying numerology information through a control channel of scheduling resource.

Here, the scheduling information can be obtained by performing a blind detection on the entire control frequency band of the scheduling resource. Alternatively, the sub-band of the blind detection may be determined according to the numerology information acquired in advance, and the control channel is detected on the determined subband to obtain the scheduling information.

The scheduling information carrying the numerology information is sent to the terminal through the control channel by the base station, so that the terminal may accurately obtain the scheduling information through the DCI or the blind detection, thereby enabling the terminal to perform data transmission on the resource with different numerology information according to the scheduling information.

Step 1302: performing data transmission on a scheduling resource based on the above scheduling information.

Optionally, the method further includes: performing the data transmission based on the scheduling information on the scheduling resource with a group of numerology information at the same time; or performing the data transmission based on the scheduling information on the scheduling resource with a plurality of groups of numerology information at the same time, to meet the requirements of different service transmissions in future mobile communication systems.

According to the terminal scheduling method in the above embodiments of the present disclosure, scheduling information carrying numerology information is acquired through a control channel of scheduling resource, and data transmission is performed on a scheduling resource based on the above scheduling information, thereby enabling the base station in the future mobile communication system to flexibly schedule the terminal to perform the data transmission on the resources with different numerology information and improving the system performance.

### First Embodiment of Terminal

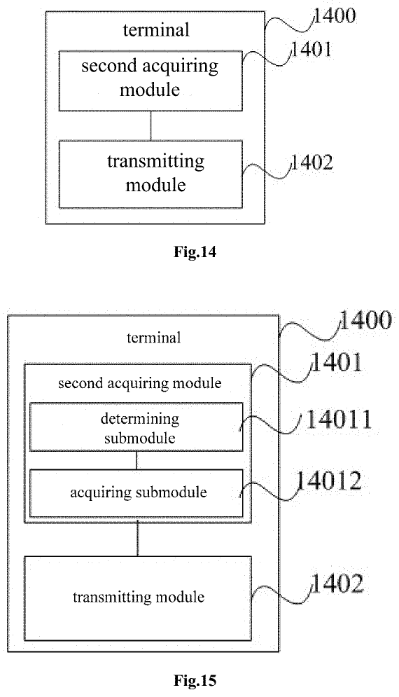

FIG. 14 is a schematic view of a terminal in the embodiments of the present disclosure. The terminal 1400 shown in FIG. 14 can implement the details of the terminal scheduling method in the foregoing method embodiment, and achieve the same or similar effects, which includes:

a second acquiring module 1401, configured to acquire scheduling information carrying numerology information sent by a base station; and

a transmitting module 1402, configured to perform data transmission on a scheduling resource based on the scheduling information.

In the terminal in the embodiments of the present disclosure, the transmitting module 1402 is configured to perform the data transmission based on the scheduling information on the scheduling resource with a group of numerology information at the same time; or

the transmitting module 1402 is configured to perform the data transmission based on the scheduling information on the scheduling resource with a plurality of groups of numerology information at the same time.

In the terminal in the embodiments of the present disclosure, the second acquiring module 1401 is configured to acquire the scheduling information carrying the numerology information through a control channel of the scheduling resource.

In the terminal in the embodiments of the present disclosure, the second acquiring module 1401 is further configured to acquire the scheduling information by performing a blind detection on the entire control frequency band of the scheduling resource.

In the terminal in the embodiments of the present disclosure, as shown in FIG. 15, the second acquiring module 1401 includes:

a determining submodule 14011, configured to determine a subband where the blind detection is performed, based on the numerology information; and

an acquiring submodule 14012, configured to detect the control channel on the determined subband to obtain the scheduling information.

It should be noted that the terminal is a terminal corresponding to the foregoing method embodiment. All the implementation manners in the foregoing method embodiments are applicable to the embodiment of the terminal, and the same or similar technical effects can be achieved.

According to the terminal in the above embodiments of the present disclosure, scheduling information carrying numerology information is acquired through a control channel of scheduling resource, and data transmission is performed on a scheduling resource based on the above scheduling information, thereby enabling the base station in the future mobile communication system to flexibly schedule the terminal to perform the data transmission on the resources with different numerology information and improving the system performance.

### Second Embodiment of Terminal

FIG. 16 is a schematic view of a terminal in the embodiments of the present disclosure. The terminal 1600 shown in FIG. 16 includes at least one processor 1601, a memory 1602, at least one network interface 1604, and other user interfaces 1603. The various components in terminal 1600 are coupled together by a bus system 1605. It will be appreciated that the bus system 1605 is used to implement connection communication between these components. The bus system 1605 includes a power bus, a control bus, and a status signal bus in addition to the data bus. However, for clarity of description, various buses are identified as bus system 1605 in FIG.

The user interface 1603 may include a display, a keyboard, or a pointing device (e.g., a mouse, a trackball, a touchpad, or a touch screen, etc.).

It is to be understood that the memory 1602 in the embodiments of the present disclosure may be a volatile memory or a non-volatile memory, or may include both volatile and non-volatile memory. The non-volatile memory may be a read-only memory (ROM), a programmable read only memory (PROM), an erasable programmable read only memory (Erasable PROM, EPROM), or an electric Erase programmable read only memory (EEPROM) or flash memory. The volatile memory can be a Random-Access Memory (RAM) that acts as an external cache. By way of example and not limitation, many forms of RAM are available, such as static random-access memory (SRAM), dynamic random-access memory (DRAM), synchronous dynamic random-access memory (Synchronous DRAM). SDRAM), Double Data Rate Synchronous Dynamic Random-Access Memory (DDRSDRAM), Enhanced Synchronous Dynamic Random-Access Memory (ESDRAM), Synchronous Connection Dynamic Random-Access Memory (SDRAM) And direct memory bus random access memory (DRRAM). The memory 1602 of the systems and methods described herein is intended to comprise, without being limited to, these and any other suitable types of memory.

In some embodiments, the memory 1602 stores elements, executable modules or data structures, or a subset thereof, or their extended set: an operating system 16021 and an application 16022.

The operating system 16021 includes various system programs, such as a framework layer, a core library layer, a driver layer, and the like, for implementing various basic services and processing hardware-based tasks. The application 16022 includes various applications, such as a media player (Media Player), a browser, and the like, for implementing various application services. A program that implements the method provided by the embodiments of the present disclosure may be included in the application 16022.

In the embodiments of the present disclosure, by calling a program or an instruction stored in the memory 1602, specifically, the program or the instruction stored in the application 16022, the processor 1601 is configured to acquire scheduling information carrying numerology information sent by the base station; and perform data transmission on a scheduling resource based on the scheduling information.

Optionally, the processor 1601 is further configured to: perform the data transmission based on the scheduling information on the scheduling resource with a group of numerology information at the same time; or perform the data transmission based on the scheduling information on the scheduling resource with a plurality of groups of numerology information at the same time.

Optionally, the processor 1601 is further configured to: acquire the scheduling information carrying the numerology information through a control channel of the scheduling resource.

Optionally, the processor 1601 is further configured to: acquire the scheduling information by performing a blind detection on the entire control frequency band of the scheduling resource.

Optionally, the processor 1601 is further configured to: determine a subband where the blind detection is performed, based on the numerology information; and detect the control channel on the determined subband to obtain the scheduling information.

According to the terminal 1600 in the above embodiments of the present disclosure, the processor 1601 is configured to acquire scheduling information carrying numerology information through a control channel of scheduling resource, and perform data transmission on a scheduling resource based on the above scheduling information, thereby enabling the base station in the future mobile communication system to flexibly schedule the terminal to perform the data transmission on the resources with different numerology information and improving the system performance.

The terminal of the present disclosure may be, for example, a mobile phone, a tablet computer, a personal digital assistant (PDA), or a car computer or the like.

The terminal 1600 can implement various processes implemented by the terminal in the foregoing embodiment. To avoid repetition, details are not described herein again.

The methods disclosed in the above embodiments of the present disclosure may be applied to the processor 1601 or implemented by the processor 1601. The processor 1601 may be an integrated circuit chip with signal processing capabilities. In the implementation process, each step of the foregoing method may be completed by an integrated logic circuit of hardware in the processor 1601 or an instruction in a form of software. The processor 1601 may be a general-purpose processor, a digital signal processor (DSP), an application specific integrated circuit (ASIC), a Field Programmable Gate Array (FPGA), or the like. Programmable logic devices, discrete gates or transistor logic devices, discrete hardware components. The methods, steps, and logical block diagrams disclosed in the embodiments of the present disclosure may be implemented or carried out. The general-purpose processor may be a microprocessor or the processor or any conventional processor or the like. The steps of the method disclosed in connection with the embodiments of the present disclosure may be directly embodied by the execution of the hardware decoding processor or by a combination of hardware and software modules in the decoding processor. The software module can be located in a conventional storage medium such as random-access memory, flash memory, read only memory, programmable read only memory or electrically erasable programmable memory, registers, and the like. The storage medium is located in the memory 1602, and the processor 1601 reads the information in the memory 1602 and completes the steps of the above method in combination with its hardware.

It will be appreciated that the embodiments described herein can be implemented in hardware, software, firmware, middleware, microcode, or a combination thereof. For hardware implementation, the processing unit can be implemented in one or more Application Specific Integrated Circuits (ASICs), Digital Signal Processing (DSP), Digital Signal Processing Equipment (DSP Device, DSPD), programmable Logic Device (PLD), Field-Programmable Gate Array (FPGA), general purpose processor, controller, microcontroller, microprocessor, other for performing the functions described herein In an electronic unit or a combination thereof.

For a software implementation, the techniques described herein can be implemented by modules (e.g., procedures, functions, and so on) that perform the functions described herein. The software code can be stored in memory and executed by the processor. The memory can be implemented in the processor or external to the processor.

### Third Embodiment of Terminal

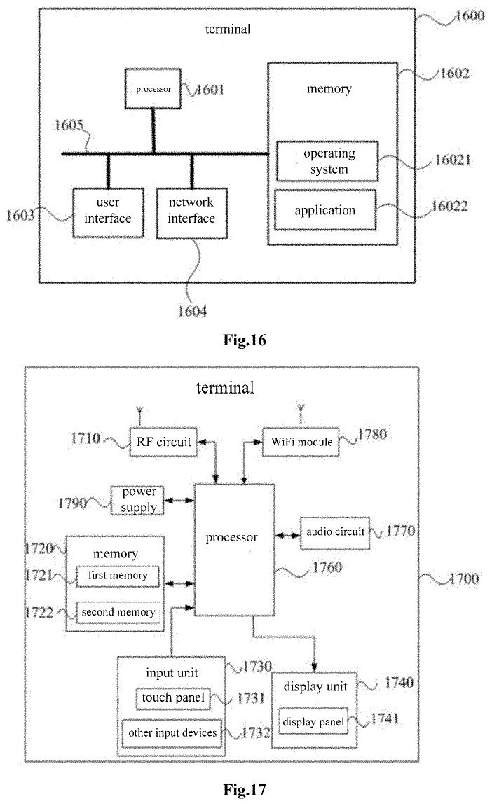

FIG. 17 is a schematic view of a terminal in the embodiments of the present disclosure. The terminal 1700 shown in FIG. 17 includes a radio frequency (RF) circuit 1710, a memory 1720, an input unit 1730, a display unit 1740, a processor 1760, an audio circuit 1770, a WiFi (Wireless Fidelity) module 1780, and a power supply 1790.

The input unit 1730 can be configured to receive numeric or character information input by the user, and generate signal inputs related to user settings and function control of the terminal 1700. Specifically, in the embodiment of the present disclosure, the input unit 1730 may include a touch panel 1731. The touch panel 1731, also referred to as a touch screen, can collect touch operations on or near the user (such as the operation of the user using any suitable object or accessory such as a finger or a stylus on the touch panel 1731), and according to the preset The programmed program drives the corresponding connection device. Optionally, the touch panel 1731 may include two parts: a touch detection device and a touch controller. The touch detection device detects the touch orientation of the user, and detects a signal brought by the touch operation, and transmits the signal to the touch controller; the touch controller receives the touch information from the touch detection device, converts the touch information into contact coordinates, and sends the touch information. The processor 1760 is provided and can receive commands from the processor 1760 and execute them. Further, the touch panel 1731 can be implemented in various types such as a resistive type, a capacitive type, an infrared ray, and a surface acoustic wave. In addition to the touch panel 1731, the input unit 1730 may further include other input devices 1732, which may include, but are not limited to, physical keyboards, function keys (such as volume control buttons, switch buttons, etc.), trackballs, mice, joysticks, and the like. One or more of them.

The display unit 1740 can be used to display information input by the user or information provided to the user and various menu interfaces of the terminal 1700. The display unit 1740 can include a display panel 1741. Alternatively, the display panel 1741 can be configured in the form of an LCD or an Organic Light-Emitting Diode (OLED).

It should be noted that the touch panel 1731 can cover the display panel 1741 to form a touch display screen.

When the touch display screen detects a touch operation on or near it, it is passed to the processor 1760 to determine the type of touch event, and then the processor 1760 provides a corresponding visual output on the touch display screen based on the type of touch event. The touch display includes an application interface display area and a common control display area. The arrangement manner of the application interface display area and the display area of the common control is not limited, and the arrangement manner of the two display areas can be distinguished by up-and-down arrangement, left-right arrangement, and the like. The application interface display area can be used to display the interface of the application. Each interface can contain interface elements such as at least one application's icon and/or widget desktop control. The application interface display area can also be an empty interface that does not contain any content. The common control display area is used to display controls with high usage, such as setting buttons, interface numbers, scroll bars, phone book icons, and the like.

The processor 1760 is a control center of the terminal 1700, and connects various parts of the entire mobile phone by using various interfaces and lines, by running or executing software programs and/or modules stored in the first memory 1721, and calling the second memory. The data in 1722 performs various functions and processing data of the terminal 1700 to perform overall monitoring of the terminal 1700. Alternatively, processor 1760 can include one or more processing units.

In the embodiments of the present disclosure, the processor 1760 is configured to, by calling a software program and/or a module stored in the first memory 1721 and/or data in the second memory 1722, acquire scheduling information carrying numerology information sent by a base station, and perform data transmission on a scheduling resource based on the scheduling information.

Optionally, the processor 1760 is further configured to: perform the data transmission based on the scheduling information on the scheduling resource with a group of numerology information at the same time; or perform the data transmission based on the scheduling information on the scheduling resource with a plurality of groups of numerology information at the same time.

Optionally, the processor 1760 is further configured to: acquire the scheduling information carrying the numerology information through a control channel of the scheduling resource.

Optionally, the processor 1760 is further configured to: acquire the scheduling information by performing a blind detection on the entire control frequency band of the scheduling resource.

Optionally, the processor 1760 is further configured to: determine a subband where the blind detection is performed, based on the numerology information acquired in advance.

The terminal provided by the embodiment of the present disclosure may be a terminal such as a mobile phone, a tablet computer, a personal digital assistant (PDA), or a car computer.

The terminal 1700 can implement various processes implemented by the terminal in the foregoing embodiment. To avoid repetition, details are not described herein again.

According to the terminal 1700 in the above embodiments of the present disclosure, the processor 1760 is configured to acquire scheduling information carrying numerology information through a control channel of scheduling resource, and perform data transmission on a scheduling resource based on the above scheduling information, thereby enabling the base station in 5G and the future mobile communication system to flexibly schedule the terminal to perform the data transmission on the resources with different numerology information and improving the system performance.

Those of ordinary skill in the art will appreciate that the elements and algorithm steps of the various examples described in connection with the embodiments disclosed herein can be implemented in electronic hardware or a combination of computer software and electronic hardware. Whether these functions are performed in hardware or software depends on the specific application and design constraints of the solution. A person skilled in the art can use different methods to implement the described functions for each particular application, but such implementation should not be considered to be beyond the scope of the present disclosure.

A person skilled in the art can clearly understand that for the convenience and brevity of the description, the specific working process of the system, the device and the unit described above can refer to the corresponding process in the foregoing method embodiment, and details are not described herein again.

In the embodiments provided by the present application, it should be understood that the disclosed apparatus and method may be implemented in other manners. For example, the device embodiments described above are merely illustrative. For example, the division of the unit is only a logical function division. In actual implementation, there may be another division manner, for example, multiple units or components may be combined or can be integrated into another system, or some features can be ignored or not executed. In addition, the coupling or direct coupling or communication connection shown or discussed may be an indirect coupling or communication connection through some interface, device or unit, and may be electrical, mechanical or otherwise.

The units described as separate components may or may not be physically separated, and the components displayed as units may or may not be physical units, that is, may be located in one place, or may be distributed to multiple network units. Some or all of the units may be selected according to actual needs to achieve the purpose of the solution of the embodiment.

In addition, each functional unit in each embodiment of the present disclosure may be integrated into one processing unit, or each unit may exist physically separately, or two or more units may be integrated into one unit.

The functions may be stored in a computer readable storage medium if implemented in the form of a software functional unit and sold or used as a standalone product. Based on such an understanding, a portion of the technical solution of the present disclosure that contributes in essence or to the prior art or a portion of the technical solution may be embodied in the form of a software product stored in a storage medium. A number of instructions are included to cause a computer device (which may be a personal computer, server, or network device, etc.) to perform all or part of the steps of the methods described in various embodiments of the present disclosure. The foregoing storage medium includes various media that can store program codes, such as a USB flash drive, a mobile hard disk, a ROM, a RAM, a magnetic disk, or an optical disk.

A person skilled in the art can understand that all or part of the process of implementing the foregoing embodiments can be implemented by a computer program to control related hardware, and the program can be stored in a computer readable storage medium. The program, when executed, may include the flow of an embodiment of the methods as described above. The storage medium may be a magnetic disk, an optical disk, a read-only memory (ROM), or a random-access memory (RAM).

The above are some embodiments of the present disclosure. A person skilled in the art may make further modifications and improvements without departing from the principle of the present disclosure, and these modifications and improvements shall also fall within the scope of the present disclosure.

1. A terminal scheduling method, applied to a base station and comprising:
sending scheduling information carrying numerology information to a terminal.

2. The terminal scheduling method according to claim 1, wherein before sending the scheduling information carrying the numerology information to the terminal, the terminal scheduling method further comprises:
configuring a scheduling resource based on characteristic information of a terminal service, to obtain the numerology information of the scheduling resource, wherein the scheduling resource is allocated by the base station to the terminal service.

3. The terminal scheduling method according to claim 1, wherein, after sending the scheduling information carrying the numerology information to the terminal, the terminal scheduling method further comprises:
receiving, data which is transmitted by the terminal based on the scheduling information on the scheduling resource with a group of numerology information at the same time; or
receiving, data which is transmitted by the terminal based on the scheduling information on the scheduling resource with a plurality of groups of numerology information at the same time.

4. The terminal scheduling method according to claim 1, wherein the sending the scheduling information carrying the numerology information to the terminal comprises:
sending the scheduling information carrying the numerology information to the terminal through a control channel.

5. The terminal scheduling method according to claim 4, wherein the sending the scheduling information carrying the numerology information to the terminal through the control channel comprises:
sending the scheduling information carrying the numerology information to the terminal through one control channel, in the case that the numerology information comprises a group of numerology information;
sending at least two scheduling information carrying the numerology information to the terminal through one or at least two control channels in the case that the numerology information comprises at least two groups of numerology information, wherein each scheduling information carries one group of numerology information in the numerology information.

6. The terminal scheduling method according to claim 5, wherein the sending the at least two scheduling information carrying the numerology information to the terminal through at least two control channels in the case that the numerology information comprises at least two groups of numerology information comprises:
sending each scheduling information to the terminal, through the control channel of a subband corresponding to the numerology information in the scheduling information.

7. The terminal scheduling method according to claim 5, wherein the sending the at least two scheduling information carrying the numerology information to the terminal through one control channels in the case that the numerology information comprises at least two groups of numerology information comprises:
sending the at least two scheduling information carrying the numerology information to the terminal, through the control channel of any subband corresponding to the numerology information in the at least two scheduling information.

8. The terminal scheduling method according to claim 5, wherein the sending the at least two scheduling information carrying the numerology information to the terminal through one control channels in the case that the numerology information comprises at least two groups of numerology information comprises:
sending the at least two scheduling information carrying the numerology information to the terminal, through a single control channel, wherein the single control channel occupies a frequency domain resource corresponding to all the numerology information, and the single control channel and the frequency domain resource corresponding to the numerology information have the same or different groups of numerology information.

9. A terminal scheduling method, applied to a terminal and comprising:
receiving scheduling information carrying numerology information sent by a base station; and
performing data transmission on a scheduling resource based on the scheduling information.

10. The terminal scheduling method according to claim 9, wherein the performing the data transmission on the scheduling resource based on the scheduling information comprises:
performing the data transmission based on the scheduling information on the scheduling resource with a group of numerology information at the same time; or
performing the data transmission based on the scheduling information on the scheduling resource with a plurality of groups of numerology information at the same time.

11. The terminal scheduling method according to claim 9,
wherein the receiving the scheduling information carrying the numerology information sent by the base station comprises:
receiving the scheduling information carrying the numerology information through a control channel of the scheduling resource.

12. The terminal scheduling method according to claim 11, wherein the receiving the scheduling information carrying the numerology information through the control channel of the scheduling resource comprises:
receiving the scheduling information by performing a blind detection on the entire control frequency band of the scheduling resource.

13. The terminal scheduling method according to claim 11, wherein the receiving the scheduling information carrying the numerology information through the control channel of the scheduling resource comprises:
determining a subband where the blind detection is performed, based on the numerology information; and
detecting the control channel on the determined subband to obtain the scheduling information.

14.-21. (canceled)

22. A terminal, comprising: a processor, a memory and a computer program stored in the memory and operable by the processor, wherein the processor executes the computer program to:
receive scheduling information carrying numerology information sent by a base station; and
perform data transmission on a scheduling resource based on the scheduling information.

23. The terminal according to claim 22, wherein the processor executes the computer program to:
perform the data transmission based on the scheduling information on the scheduling resource with a group of numerology information at the same time; or
perform the data transmission based on the scheduling information on the scheduling resource with a plurality of groups of numerology information at the same time.

24. The terminal according to claim 22, wherein the processor executes the computer program to: receive the scheduling information carrying the numerology information through a control channel of the scheduling resource.

25. The terminal according to claim 24, wherein the processor executes the computer program to: receive the scheduling information by performing a blind detection on the entire control frequency band of the scheduling resource.

26. The terminal according to claim 24, wherein the processor executes the computer program to:
determine a subband where the blind detection is performed, based on the numerology information; and
detect the control channel on the determined subband to obtain the scheduling information.

27.-30. (canceled)
